(19) United States
(12) Patent Application Publication
(10) Pub. No.: US 2014/0296461 A1
(43) Pub. Date: Oct. 2, 2014

(54) Aromatic Vinyl Copolymer, Method for Preparing the Same, and Molded Article Including the Same

(71) Applicant: Cheil Industries Inc., Gumi-si (KR)

(72) Inventors: Beom Jun JOO, Uiwang-si (KR); Sun Dae KIM, Uiwang-si (KR)

(73) Assignee: Cheil Industries Inc., Gumi-si (KR)

(21) Appl. No.: 14/223,162

(22) Filed: Mar. 24, 2014

(30) Foreign Application Priority Data
Mar. 28, 2013 (KR) 10-2013-0033633

(51) Int. Cl. C08F 24/00; C08F 4/04; C08F 4/34

(52) U.S. Cl. CPC C08F 24/00; C08F 4/34; C08F 4/04
USPC 526/219.6; 526/232.1

(57) ABSTRACT

An aromatic vinyl copolymer can exhibit excellent heat resistance and/or transparency and is a copolymer of a monomer mixture, which includes: an exo-methylene butyrolactone compound represented by Formula 1; an aromatic vinyl compound; and a vinyl cyanide compound.

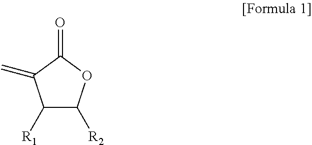

wherein R₁ and R₂ are each independently hydrogen, C₁ to C₁₂ alkyl, or C₆ to C₁₂ aryl.

### CROSS-REFERENCE TO RELATED APPLICATION

This application claims priority under 35 USC Section 119 to and the benefit of Korean Patent Application No. 10-2013-0033633, filed Mar. 28, 2013, the entire disclosure of which is incorporated herein by reference.

### FIELD OF THE INVENTION

The present invention relates to an aromatic vinyl copolymer, a method for preparing the same, and a molded article including the same.

### BACKGROUND OF THE INVENTION

Polystyrene is a transparent polymer which is relatively low-priced and exhibits good optical properties. However, since polystyrene has a glass transition temperature (T_{g}) of about 95° C. and thus exhibits insufficient heat resistance, polystyrene is not used in the production of backlight units (BLUs) and automobiles, which require high heat resistance. Thus, if high heat resistant polystyrene polymers can be prepared through copolymerization with other monomers, it is expected that new markets will be created. Particularly, it is expected that high heat resistant polystyrene could be used in electronic products and automobile materials by replacing polycarbonate (PC) or polymethyl methacrylate (PMMA), which are currently widely used as transparent plastics.

In order to improve heat resistance of polystyrene, α-methylstyrene or N-phenylmaleimide is generally used as a monomer for copolymerization in the art. α-methylstyrene can improve heat resistance by introducing a methyl group to an α position of styrene and restricting molecular movement in the preparation of copolymers. N-phenylmaleimide can improve heat resistance by introducing a maleimide structure.

However, when α-methylstyrene is used for improvement of heat resistance, there is a serious problem in that the copolymer can be decomposed by de-polymerization upon temperature increase, and when N-phenylmaleimide is used as a monomer for copolymerization, there are problems in colors of the copolymer and transparency deterioration.

### SUMMARY OF THE INVENTION

The present invention provides an aromatic vinyl copolymer including an exo-methylene butyrolactone compound that can exhibit excellent properties in terms of heat resistance and/or transparency, a method for preparing the same, and a molded article including the same.

The aromatic vinyl copolymer is a copolymer of a monomer mixture including: an exo-methylene butyrolactone compound represented by Formula 1; an aromatic vinyl compound; and a vinyl cyanide compound.

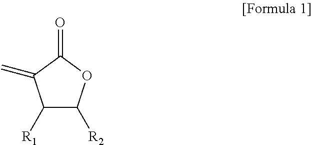

wherein R₁ and R₂ are the same or different and are each independently hydrogen, C₁ to C₁₂ alkyl, or C₆ to C₁₂ aryl.

In one embodiment, the exo-methylene butyrolactone compound may be an exo-methylene butyrolactone compound in which R₁ is C₁ to C₁₂ alkyl or C₆ to C₁₂ aryl.

In one embodiment, the monomer mixture may include about 1 wt % to about 50 wt % of the exo-methylene butyrolactone compound, about 30 wt % to about 90 wt % of the aromatic vinyl compound, and about 5 wt % to about 60 wt % of the vinyl cyanide compound.

In one embodiment, the aromatic vinyl compound may include styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, or a combination thereof.

In one embodiment, the vinyl cyanide compound may include acrylonitrile, methacrylonitrile, ethacrylonitrile, or a combination thereof.

In one embodiment, the monomer mixture may further include a monomer comprising a C₁ to C₁₂ alkyl (meth)acrylate, (meth)acrylic acid, maleic anhydride, N-substituted maleimide, or a combination thereof.

In one embodiment, the aromatic vinyl copolymer may have a weight average molecular weight from about 10,000 g/mol to about 100,000 g/mol.

In one embodiment, the aromatic vinyl copolymer may have a glass transition temperature (T_{g}) from about 110° C. to about 180° C., and an initial decomposition temperature from about 340° C. to about 400° C. as measured by thermogravimetric analysis (TGA).

In one embodiment, the aromatic vinyl copolymer may have a haze value of less than about 1%, and a light transmittance from about 90% to about 94%, as measured on a 2.5 mm thick specimen.

The present invention also relates to a method for preparing an aromatic vinyl copolymer. The method includes, in the presence of an initiator, polymerizing a monomer mixture including: an exo-methylene butyrolactone compound represented by Formula 1; an aromatic vinyl compound; and a vinyl cyanide compound.

In one embodiment, the monomer mixture may further include a monomer comprising a C₁ to C₁₂ alkyl (meth)acrylate, (meth)acrylic acid, maleic anhydride, N-substituted maleimide, or a combination thereof.

The present invention also relates to a molded article produced from the aromatic vinyl copolymer.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

An aromatic vinyl copolymer according to embodiments of the invention is a copolymer formed by copolymerization of a monomer mixture that includes an exo-methylene butyrolactone compound, an aromatic vinyl compound, and a vinyl cyanide compound.

(A) Exo-Methylene Butyrolactone Compound

According to the invention, the exo-methylene butyrolactone compound is included as a repeat unit in the copolymer, can restrict molecular movement of the copolymer to improve heat resistance of the copolymer, and is represented by Formula 1:

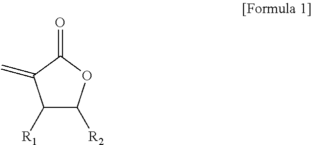

wherein R₁ and R₂ are the same or different and are each independently hydrogen, C₁ to C₁₂ alkyl, for example C₁ to C₅ alkyl, or C₆ to C₁₂ aryl, for example C₆ to C₁₀ aryl.

In one embodiment, the exo-methylene butyrolactone compound may be a β position-substituted exo-methylene butyrolactone compound, in which R₁ is C₁ to C₁₂ alkyl, for example C₁ to C₅ alkyl, or C₆ to C₁₂ aryl, for example C₆ to C₁₀ aryl, and as another example C₁ to C₄ alkyl. In this case, the aromatic vinyl copolymer can exhibit improved heat resistance and transparency.

As used herein, the term “alkyl” refers to a linear, branched and/or cyclic alkyl, and the terms “alkyl” and “aryl” may refer to alkyl and aryl groups, respectively, in which a hydrogen atom is unsubstituted (unsubstituted alkyl and/or unsubstituted aryl) or is substituted (substituted alkyl and/or substituted aryl) with one or more substituents such as C₁ to C₁₀ alkyl, C₆ to C₁₂ alkyl, halogen, and the like, and combinations thereof.

Examples of the exo-methylene butyrolactone compound may include without limitation α-methylene-γ-butyrolactone, β-methyl-α-methylene-y-butyrolactone, β-ethyl-α-methylene-γ-butyrolactone, β-butyl-α-methylene-y-butyrolactone, and the like, and combinations thereof.

The aromatic vinyl copolymer can include the exo-methylene butyrolactone compound in an amount of about 1% by weight (wt %) to about 50 wt %, for example about 5 wt % to about 30 wt %, based on the total weight (100 wt %) of the monomer mixture used to make the same (and also based on the total weight, or 100 wt %, of the aromatic vinyl copolymer). In some embodiments, the aromatic vinyl copolymer may include the exo-methylene butyrolactone compound in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the exo-methylene butyrolactone compound can be in a range from about any of the foregoing amounts to about any other of the foregoing amounts.

When the aromatic vinyl copolymer includes the exo-methylene butyrolactone compound in an amount within this range, the aromatic vinyl copolymer can exhibit excellent properties in terms of heat resistance, transparency, and the like.

(B) Aromatic Vinyl Compound

The aromatic vinyl compound may employ an aromatic vinyl monomer used in typical aromatic vinyl polymers and copolymers. Examples of the aromatic vinyl compound may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and combinations thereof. In exemplary embodiments, the aromatic vinyl compound includes styrene.

The aromatic vinyl copolymer can include the aromatic vinyl compound in an amount of about 30 wt % to about 90 wt %, for example about 40 wt % to about 80 wt %, based on the total weight (100 wt %) of the monomer mixture used to make the same (and also based on the total weight, or 100 wt %, of the aromatic vinyl copolymer). In some embodiments, the aromatic vinyl copolymer can include the aromatic vinyl compound in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl compound can be in a range from about any of the foregoing amounts to about any other of the foregoing amounts.

When the aromatic vinyl copolymer includes the aromatic vinyl compound in an amount within this range, the aromatic vinyl copolymer can exhibit excellent properties in terms of heat resistance, transparency, and the like.

(C) Vinyl Cyanide Compound

Examples of the vinyl cyanide compound may include without limitation acrylonitrile, methacrylonitrile, ethacrylonitrile, and the like, and combinations thereof In exemplary embodiments, the vinyl cyanide compound includes acrylonitrile.

The aromatic vinyl copolymer can include the vinyl cyanide compound in an amount of about 5 wt % to about 60 wt %, for example about 10 wt % to about 50 wt %, based on the total weight (100 wt %) of the monomer mixture used to make the same (and also based on the total weight, or 100 wt %, of the aromatic vinyl copolymer). In some embodiments, the aromatic vinyl copolymer can include the vinyl cyanide compound in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the vinyl cyanide compound can be in a range from about any of the foregoing amounts to about any other of the foregoing amounts.

When the aromatic vinyl copolymer includes the vinyl cyanide compound in an amount within this range, the aromatic vinyl copolymer can exhibit excellent properties in terms of heat resistance, transparency, and the like.

In some embodiments, the aromatic vinyl copolymer may further include a monomer for imparting processability and heat resistance, as needed. Examples of the monomer for imparting processability and heat resistance include without limitation C₁ to C₁₂ alkyl (meth)acrylates, (meth)acrylic acids, maleic anhydride, N-substituted maleimides, and the like, and combinations thereof.

The aromatic vinyl copolymer can optionally include a monomer for imparting processability and heat resistance in an amount of about 15 parts by weight or less, for example from about 0.1 parts by weight to about 10 parts by weight, based on about 100 parts by weight of the monomer mixture used to make the same (and also based on the total weight, or 100 wt %, of the aromatic vinyl copolymer). In some embodiments, the aromatic vinyl copolymer can include the monomer for imparting processability and heat resistance in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 parts by weight. Further, according to some embodiments of the present invention, the amount of the monomer for imparting processability and heat resistance can be in a range from about any of the foregoing amounts to about any other of the foregoing amounts.

Within this range, the monomer for imparting processability and heat resistance can impart processability and/or heat resistance to the aromatic vinyl copolymer with minimal or no deterioration of other properties.

The aromatic vinyl copolymer can have a weight average molecular weight from about 10,000 g/mol to about 100,000 g/mol, for example from about 40,000 g/mol to about 70,000 g/mol, as measured by gel permeation chromatography (GPC). Within this range, the aromatic vinyl copolymer can exhibit excellent properties in terms of heat resistance, transparency, processability, and the like.

The aromatic vinyl copolymer can have a glass transition temperature (T_{g}) from about 110° C. to about 180° C., for example from about 120° C. to about 150° C., and has an initial decomposition temperature from about 340° C. to about 400° C., for example from about 360° C. to about 380° C., as measured by thermogravimetric analysis (TGA). Herein, the term “initial decomposition temperature” is defined as a temperature at which an initial specimen weight is decreased by about 5% at a heating rate of 20° C./min using TGA.

The aromatic vinyl copolymer can have a haze value of less than about 1%, preferably from about 0.01% to about 0.6%, and can have a light transmittance from about 90% to about 94%, for example from about 92% to about 94%, as measured on a 2.5 mm thick specimen.

The aromatic vinyl copolymer according to embodiments of the present invention may be prepared by typical methods for preparing an aromatic vinyl copolymer. For example, the aromatic vinyl copolymer may be prepared by (co)polymerizing, in the presence of an initiator, a monomer mixture that includes an exo-methylene butyrolactone compound represented by Formula 1, an aromatic vinyl compound and a vinyl cyanide compound. More particularly, the aromatic vinyl copolymer may be prepared by radical polymerization, without being limited thereto, as shown in Reaction Formula 1:

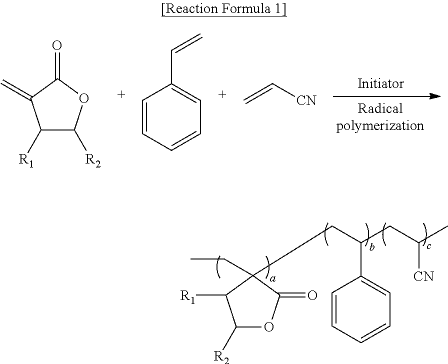

wherein R₁ and R₂ are defined as in Formula 1, and a, b and c are wt % values of each repeat unit, for example, a, b and c may be from about 1 wt % to about 50 wt %, from about 30 wt % to about 90 wt %, and from about 5 wt % to about 60 wt %, respectively.

As the initiator, typical radical polymerization initiators may be used. Examples of the initiator include without limitation organic peroxides, such as benzoyl peroxide (BPO), t-butyl peroxyacetate, di-t-butyl peroxide, t-butyl peroxypivalate, t-butyl peroxy-2-ethyl hexanoate, t-butyl peroxyneodecanoate, t-butyl peroxyisobutylate, t-butyl peroxybenzoate, t-amyl peroxyneodecanoate, t-amyl peroxypivalate, t-amyl peroxy-2-ethyl hexanoate, and the like, and mixtures thereof; and/or azo compounds, such as 2,2′-azobisisobutyronitrile (AIBN), 1,1′-azobiscyclohexanecarbonitrile, 2,2′-azobis-2-methylpropionamidine, and the like, and mixtures thereof.

An amount of the initiator to be used may be selected in consideration of half-life of the initiator, reaction temperature, molecular weight of a copolymer to be obtained, reaction time, and the like. For example, the initiator may be present in an amount of about 0.01 parts by weight to about 10 parts by weight based on about 100 parts by weight of the monomer mixture, without being limited thereto.

In addition, polymerization may be performed by mass polymerization, solution polymerization, emulsion polymerization, suspension polymerization, or the like. In exemplary embodiments, mass polymerization or solution polymerization is used.

Upon copolymerization, although polymerization temperature and pressure may vary according to polymerization methods, initiators, and the like, the polymerization temperature can range, for example, from about 50° C. to about 150° C., for example from about 60° C. to about 120° C., and the polymerization pressure can range from about 1 kgf/cm² to about 2 kgf/cm², without being limited thereto.

In addition, upon copolymerization, an organic solvent may be used as a reaction medium. The organic solvent may employ organic solvents used in polymerization of typical aromatic vinyl copolymers. Examples of the organic solvent include without limitation toluene, benzene, xylene, dimethylformamide (DMF), tetrahydrofuran, diethyl ether, and the like, and combinations thereof. In exemplary embodiments, the organic solvent includes toluene.

The preparation method may further include adding a monomer for imparting processability and heat resistance, and/or additives such as plasticizers, cross-linking agents, heat stabilizers, colorants, ultraviolet absorbers, and the like, and combinations thereof, as needed, without being limited thereto.

Examples of the monomer for imparting processability and heat resistance include without limitation C₁ to C₁₂ alkyl (meth)acrylates, (meth)acrylic acids, maleic anhydride, N-substituted maleimides, s and the like, and combinations thereof.

The monomer for imparting processability and heat resistance is optionally present in an amount of about 15 parts by weight or less, for example from about 0.1 parts by weight to about 10 parts by weight, based on about 100 parts by weight of the total monomer mixture.

Within this range, the monomer for imparting processability and heat resistance can impart processability and heat resistance to the aromatic vinyl copolymer with minimal or no deterioration of other properties.

After completion of the polymerization of the aromatic vinyl copolymer according to the embodiments of the invention, the aromatic vinyl copolymer may be prepared in pellet form or the like through typical post-treatment and a processing process, and may be molded into various molded articles. For example, the aromatic vinyl copolymer may be prepared as high heat resistant optical plastics, plastics for automobiles, and the like, without being limited thereto. The molded articles can be easily formed by those skilled in the art.

Next, the present invention will be explained in more detail with reference to the following examples. It should be understood that these examples are provided for illustration only and are not to be in any way construed as limiting the present invention.

### EXAMPLES

### Examples 1 to 5

According to the compositions as listed in Table 1, with benzoyl peroxide (BPO) or azobisisobutyronitrile (AIBN) placed as an initiator in a 100 ml round bottom flask, the flask is filled with toluene, styrene (SM), acrylonitrile (AN), and β-methyl-α-methylene-γ-butyrolactone (MMBL) in order. Then, these components are stirred for 17 hours while gradually elevating the temperature of the reactant to 60° C. to 90° C. After completion of polymerization, the temperature of the reactant is decreased to room temperature, and 20 ml of chloroform is added to the reactant, followed by stirring for 10 minutes. Then, the resultant is gradually added dropwise to 500 ml of methanol, thereby forming precipitates. After being filtered, the precipitates are washed with methanol and dried in a vacuum oven, thereby preparing an aromatic vinyl copolymer. Obtained mass and yield of the prepared aromatic vinyl copolymers are shown in Table 1. A weight average molecular weight (M_{w}), number average molecular weight (Mₙ) and polydispersity index (PDI) of the prepared aromatic vinyl copolymers are measured by gel permeation chromatography (GPC) using tetrahydrofuran (THF) as a solvent, and results are shown in Table 1. In Table 1, the amounts of the initiator and the solvent are represented in parts by weight based on 100 parts by weight of a monomer mixture.

### Comparative Example

An aromatic vinyl copolymer (SAN resin) is prepared in the same manner as in Example 1 except that β-methyl-α-methylene-γ-butyrolactone (MMBL) is not added.

TABLE 1

| | | | | | | | Comparative |
|---|---|---|---|---|---|---|---|
| | | Example 1 | Example 2 | Example 3 | Example 4 | Example 5 | Example |
| Added amount | SM | 61 | 61 | 61 | 51 | 51 | 68 |
| (wt %) | AN | 29 | 29 | 29 | 29 | 29 | 32 |
| | MMBL | 10 | 10 | 10 | 20 | 20 | — |
| Initiator | | BPO | AIBN | AIBN | BPO | AIBN | BPO |
| Added amount (parts by | | 0.3 | 0.3 | 0.3 | 0.3 | 0.3 | 0.3 |
| weight) | | | | | | | |
| Solvent | | Toluene | Toluene | Toluene | Toluene | Toluene | Toluene |
| Added amount (parts by | | 150 | 150 | 100 | 100 | 100 | 100 |
| weight) | | | | | | | |
| Reaction temperature (° C.) | | 90 | 60 | 60 | 60 | 60 | 90 |
| Obtained mass (g) | | 4.1 | 5.9 | 5.9 | 4.2 | 5.8 | 20.6 |
| Yield (%) | | 51 | 74 | 73 | 52 | 72 | 85 |
| Molecular weight | Mn | 33.4K | 40.3K | 43.9K | 25.1K | 33.3K | 45.9K |
| (THF) | Mw | 56.9K | 68.4K | 77.3K | 40.9K | 58.0K | 81.7K |
| | PDI | 1.7 | 1.7 | 1.8 | 1.6 | 1.7 | 1.8 |

Evaluation of Properties

The aromatic vinyl copolymers prepared in Examples and Comparative Example are evaluated with regard to glass transition temperature, initial decomposition temperature and transparency (haze and light transmittance) by the following methods, and results are shown in Table 2.

(1) Glass transition temperature (T_{g}, unit: ° C.): The glass transition temperature is measured using a differential scanning calorimeter (DSC) Q20 (TA Instruments). Measurement is carried out in a nitrogen atmosphere within a temperature range from 30° C. to 400° C. under a heating rate of 10° C./min and a cooling rate of 10° C./min, and the glass transition temperature is determined as a temperature measured upon second heating.

(2) Initial decomposition temperature (TGA (5%), unit: ° C.): A temperature at which an initial specimen weight is decreased by 5% thereof is measured at a heating rate of 20 ° C./min using a thermogravimetric analyzer (TGA).

(3) Transparency: After preparing 2.5 mm thick specimens of each injection molded article, light transmittance (total light transmittance, total transmitted light (TT), unit: %) and a haze value (unit: %) are measured. To evaluate transparency of each specimen, the total transmitted light (TT) and the haze value are measured using a haze meter NDH 2000 (Nippon Denshoku Co., Ltd.), and the total transmitted light (TT) is calculated as a total amount of diffuse transmitted light (DF) and parallel transmitted light (PT). Here, a higher total transmitted light (TT) and a lower haze value indicate higher transparency.

TABLE 2

| | | | | | | Comparative |
|---|---|---|---|---|---|---|
| | Example 1 | Example 2 | Example 3 | Example 4 | Example 5 | Example |
| Glass transition temperature | 128° C. | 129° C. | 132° C. | 149° C. | 145° C. | 106° C. |
| Initial decomposition | 374° C. | 377° C. | 370° C. | 373° C. | 367° C. | — |
| temperature | | | | | | |
| Light transmittance (%) | 92 | 92 | 92 | 93 | 93 | 92 |
| Haze (%) | 0.5 | 0.5 | 0.5 | 0.5 | 0.5 | 1 |

From the results shown in Table 1, it can be seen that the aromatic vinyl copolymers according to the present invention (Examples 1 to 5) have a glass transition temperature of 128° C. or more and an initial decomposition temperature of 367° C. or more, and thus exhibit superior heat resistance and excellent transparency.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An aromatic vinyl copolymer which is a copolymer of a monomer mixture comprising: an exo-methylene butyrolactone compound represented by Formula 1; an aromatic vinyl compound; and a vinyl cyanide compound. 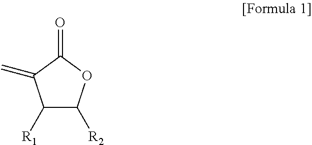
wherein R₁ and R₂ are the same or different and are each independently hydrogen, C₁ to C₁₂ alkyl, or C₆ to C₁₂ aryl.

2. The aromatic vinyl copolymer according to claim 1, wherein the exo-methylene butyrolactone compound is an exo-methylene butyrolactone compound in which R₁ is C₁ to C₁₂ alkyl or C₆ to C₁₂ aryl.

3. The aromatic vinyl copolymer according to claim 1, wherein the monomer mixture comprises about 1 wt % to about 50 wt % of the exo-methylene butyrolactone compound, about 30 wt % to about 90 wt % of the aromatic vinyl compound, and about 5 wt % to about 60 wt % of the vinyl cyanide compound.

4. The aromatic vinyl copolymer according to claim 1, wherein the aromatic vinyl compound comprises styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, or a combination thereof.

5. The aromatic vinyl copolymer according to claim 1, wherein the vinyl cyanide compound comprises acrylonitrile, methacrylonitrile, ethacrylonitrile, or a combination thereof

6. The aromatic vinyl copolymer according to claim 1, wherein the monomer mixture further comprises a monomer comprising C₁ to C₁₂ alkyl (meth)acrylate, (meth)acrylic acid, maleic anhydride, N-substituted maleimide, or a combination thereof

7. The aromatic vinyl copolymer according to claim 1, wherein the copolymer has a weight average molecular weight from about 10,000 g/mol to about 100,000 g/mol.

8. The aromatic vinyl copolymer according to claim 1, wherein the copolymer has a glass transition temperature (T_{g}) from about 110° C. to about 180° C., and an initial decomposition temperature from about 340° C. to about 400° C. as measured by thermogravimetric analysis (TGA).

9. The aromatic vinyl copolymer according to claim 1, wherein the copolymer has a haze value of less than about 1%, and a light transmittance from about 90% to about 94%, as measured on a 2.5 mm thick specimen.

10. A method for preparing an aromatic vinyl copolymer, comprising: in the presence of an initiator, polymerizing a monomer mixture comprising an exo-methylene butyrolactone compound represented by Formula 1, an aromatic vinyl compound, and a vinyl cyanide compound: 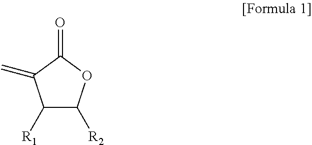
wherein R₁ and R₂ are the same or different and are each independently hydrogen, C₁ to C₁₂ alkyl, or C₆ to C₁₂ aryl.

11. The method according to claim 10, wherein the monomer mixture further comprises a monomer comprising C₁ to C₁₂ alkyl (meth)acrylate, (meth)acrylic acid, maleic anhydride, N-substituted maleimide, or a combination thereof

12. A molded article produced from the aromatic vinyl copolymer according to claim 1.
